(19) United States
(12) Patent Application Publication
(10) Pub. No.: US 2008/0072999 A1
(43) Pub. Date: Mar. 27, 2008

(54) Method and apparatus for recovering partial sized sheets in veneer production

(75) Inventor: Jussi Puranen, Lahti (FI)

Correspondence Address: BUCHANAN, INGERSOLL & ROONEY PC, POST OFFICE BOX 1404, ALEXANDRIA, VA, 22313-1404, US

(73) Assignee: Raute Oyj, Nastola (FI)

(21) Appl. No.: 11/902,173

(22) Filed: Sep. 19, 2007

(30) Foreign Application Priority Data
Sep. 21, 2006 (FI) 20060841

(51) Int. Cl. B23Q 15/007

(52) U.S. Cl. 144/357

(57) ABSTRACT

The invention concerns a method for recovering partial sized veneer sheets in the veneer production. A veneer sheeting peeled from a log is monitored with a machine vision device for detecting and localizing defects and defining corresponding partial sized sheet sections in the veneer sheeting. The partial sized sections of the veneer sheeting are evaluated for sound veneer in veneer lengths of a multiple of 2′+n′. The partial sized veneer sheets are cut as sound veneer sections in the longitudinal and transversal direction of the veneer sheeting controlled on the evaluation of value factors of the sections.

### TECHNICAL FIELD

The present invention concerns a veneer producing method where partial sized sheets are utilized, implementing the method so that the grade value of a sheet is taken into account in determining the trimming size of the actual sheet to be utilized. The invention also concerns an apparatus for implementing said method.

### BACKGROUND OF THE INVENTION

In the production of veneer to be used for manufacturing plywood, it is unavoidable, that when peeling the log at the initial stage of the peeling, there are veneer sections produced, where the veneer sheeting is not complete or sound at the total dimensions thereof. The defect areas originate from protrusions and pits of the log surface and from the defective wood in the log, like rotten wood, knots, pitch pockets. The defective sections of the veneer sheeting are tried to be minimized by defining the log contour before peeling and clamping the log to the lathe chucks in the most favourable way, based on this determination.

One objective can also be the maximizing of the amount of the peeled veneer which can be utilized as face veneer in plywood. In that case there can be situations when peeling asymmetric logs, where the veneer sheeting in the initial stage of the peeling consists of separate sections of good quality face veneer contiguous to fishtail and defective areas.

The veneer section including defects is controllably trimmed to such veneer widths (as the width of the veneer sheeting is considered traditionally the dimension across the grain direction), that the defect areas can be removed from the veneer web. In that way the veneer widths trimmed out randomly are sound veneer, and will used as full size sheets by jointing along their grain direction edges. These jointed sheets are then used in plywood production for the suitable plies of the plywood.

A sheet remaining from the trimming includes the defect area, but contains at least over a part of the length (in the grain direction) thereof, sound veneer. Various methods have been proposed to utilize that sound part of the out-trimmed part of the veneer sheeting. For example the Patent publication EP 0 097 794 discloses a method and an apparatus, where a veneer section including defect areas in a veneer sheeting is severed in the grain direction of the sheeting into relatively narrow stripes. Then, each stripe is taken to controlled cutting, where the defect area of the section is removed by cutting across the grain direction. The yielded sound veneer stripe is jointed to an end of another similarly trimmed veneer stripe section into a principally continuous veneer ribbon. Predetermined lengths are cut from this veneer ribbon to be bonded side-by-side to form a veneer sheet. The yielded sheet is used as a suitable ply for plywood.

Also a procedure in known, where a defect area of a veneer sheeting is slit in the advancing direction of the sheeting into two halves prior to the cross cuts afore and behind the defect area of the sheeting. The cross cuts are separately controlled for each of the halves, giving the possibility to larger saved half-areas than if the defective area would be trimmed out afore and after the defective area by common cuts across the sheeting. These veneer half-sections are used to full-sized sheets.

Said methods known in the art, however, leave a part of the usable veneer unused, and this veneer will be wasted along with the trash veneer.

### SUMMARY OF THE INVENTION

In that respect, an improvement of utilizing the veneer has been provided by means of the method in accordance with the present invention in which method the veneer sheeting peeled from a log is monitored for defects with a machine vision device, the defective sections of the sheeting are evaluated and localized as partial sheet sections on the monitored defect information, each of the partial sheet section is evaluated for the sound veneer as areas having a length of at least 2′+n′, a value factor is given for each of said length of sound veneer, the partial sheet sections are separated by first cuts in the transversal direction of the veneer sheeting, and the partial sheet sections are severed by second cuts into sound veneer lengths selecting the lines for the second cuts producing maximized value factors for the lengths of said 2′+n′.

When implementing the invention, weighted value factors with respect to the length of the veneer portion are used for controlling the evaluation of the area to be utilized. The veneer section that is received as a long stripe (dimension in the grain direction) has in general priority over the veneer to be cut as shorter but wider pieces, in other words, the length can be provided with a higher value factor, even at the expense of the total area.

The apparatus applicable for implementing the present invention comprises, a machine vision devices for monitoring the veneer sheeting for defects, a cutter cutting the veneer sheeting transversally in partial veneer sheet sections, an apparatus performing logical calculations on the monitored defect information and controlling the operation the cutter, and the apparatus further includes cutting means for selectively cutting the partial veneer sheet sections in selected lengths on command of said apparatus performing logical calculations.

### DESCRIPTION OF THE DRAWINGS

The invention will be described in more detail by means of the enclosed drawing, wherein

FIG. 1 shows the cutting lines of a veneer sheeting when implementing the invention,

FIG. 2 is a principal illustration of an apparatus for implementing the invention, and

FIG. 3 is a complemented side view of the apparatus in accordance with FIG. 2.

### DETAILED DESCRIPTION OF AN EMBODIMENT

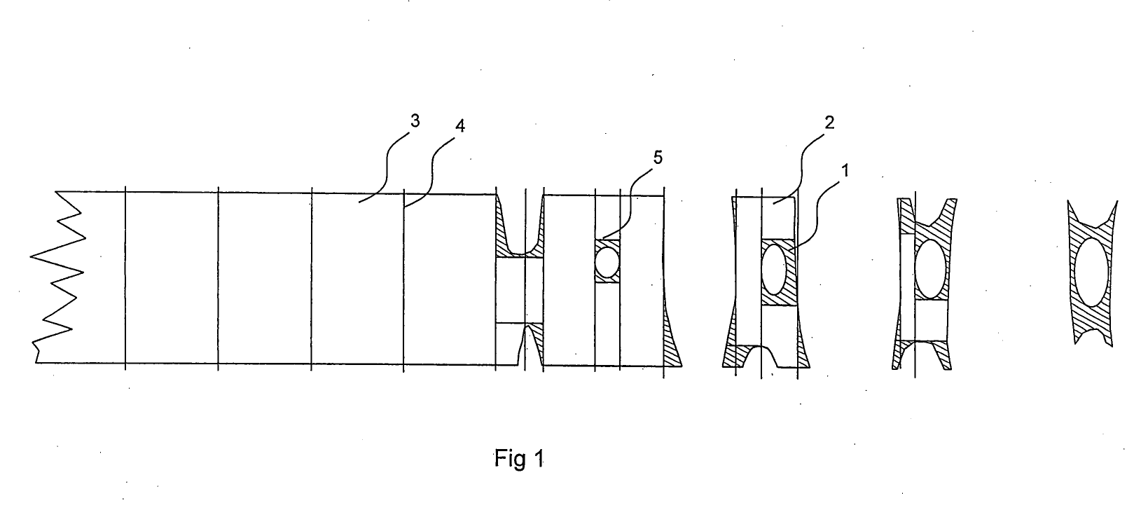

The FIG. 1 shows a principal illustration of the veneer sheeting received from a contoured log with a significantly oval cross section, at the initial stage of the veneer peeling. The leading end of the veneer sheeting is shown at the right in FIG. 1.

The grain direction of the veneer sheeting is equal to the cross direction of the veneer sheeting, said direction being traditionally considered as the length direction of the veneer. Thus, the dimension of the veneer in this direction equals to the length of the log, from the circumference of which the veneer is tangentially peeled. The length of the veneer is globally expressed in feet (for instance 6′, 8′, 10′ and so on).

The dimension of the sheet in the direction of progress the sheeting, in other words perpendicular to the grain direction, is traditionally considered as the width of the veneer sheet cut from the sheeting (a full size sheet, for instance 4′×8′ from a log with a length of 8′).

Striped areas, like area 1 are areas to be cut off as trash veneer from the veneer sheeting, sound areas are areas that can be utilized by means of the method in accordance with the invention. The cutting lines are marked in the figure with solid lines, on one hand in the transversal direction of the sheeting, line 4, and on the other hand in the web direction, line 5. The cuts 4 in the transversal direction of the sheeting are made prior to the cuts in the sheeting direction 5. In practice, the veneer sheets separated by the cuts in the transversal direction of the sheeting are brought to accelerated forward motion for facilitating the cuttings 5.

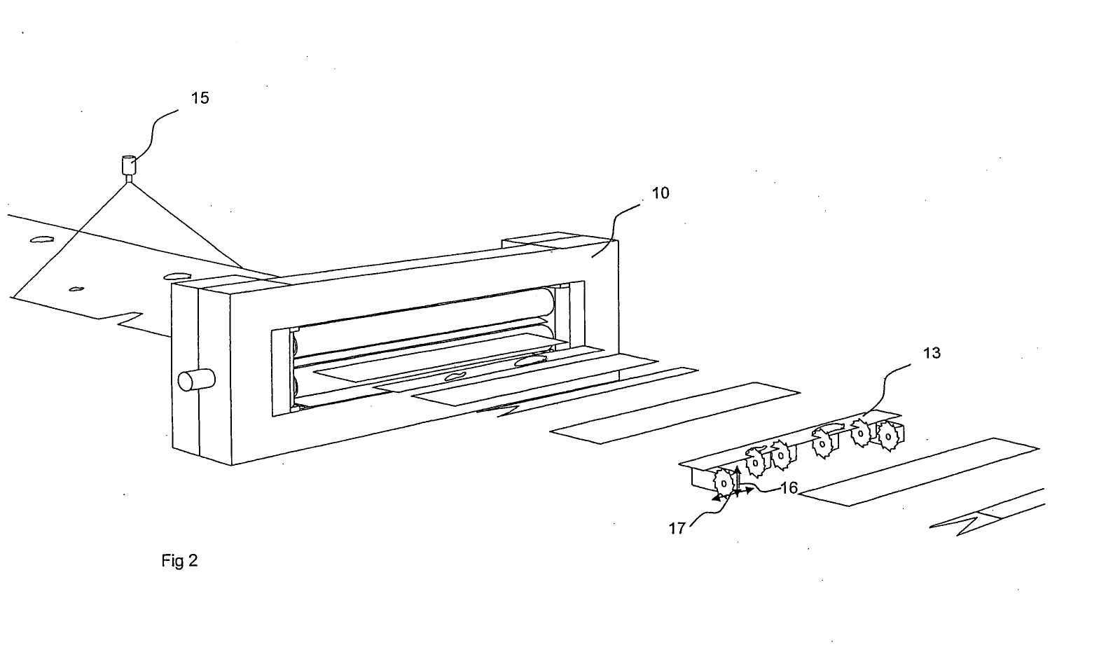

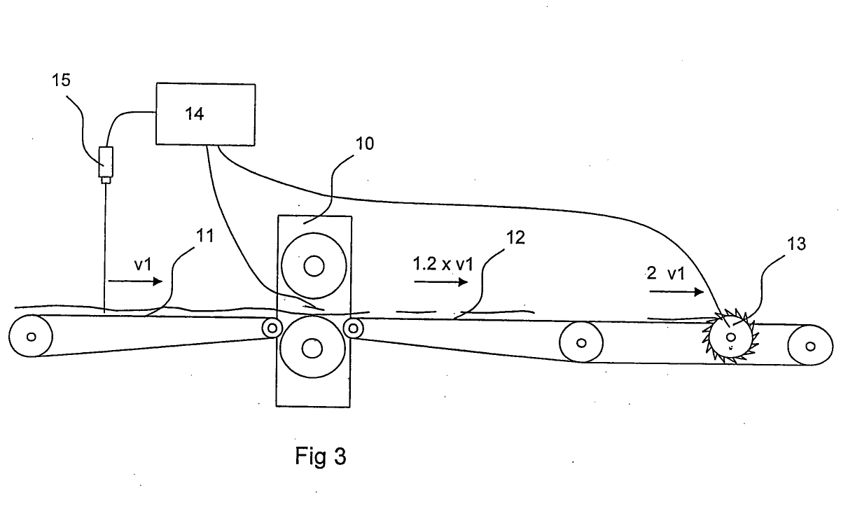

When implementing the invention, the veneer sheeting is monitored with machine vision devices 15, as shown in FIGS. 2 and 3. As known in the art, it is possible by means of these devices to detect the defects of the veneer. Detection of the defects combined with the data on the advancing of the veneer are given to the device that gives the control data to the cutter 10 about the cutting lines in the transversal direction of the sheeting, whereby the portion including the defect area can be separated from the sound sheeting, maximizing simultaneously the area of the sound sheeting portion remaining to the separated part, and taking thereby into account also the length of the portion to be utilized.

After this cutting, the web parts are brought to accelerated forward motion (FIG. 3) and passed to a second cutting performed by means of cutter devices 13, where the veneer sections with optimized widths, including defects, are controllably cut across the grain direction. The cutting lines for the cutting devices 13 have been selected performing optimization calculations at the computer device 14, on the basis of the criteria of 2′+n′ for the length of a stripe to be utilized, where n is a multiple of full foot, usually from 1 to 6.

When cutting a partial veneer section, the primary aim can be for example to prefer a certain dimension for utilization. A value factor of 1 can be given for this dimension for the optimization calculations, and an other dimension that matches with this strived dimension in the further processing, will be provided with value factor like 0,8. The dimension that is not desired at all, will be provided with a low value factor, for example 0.2 or even 0, in case the dimension in question should be totally excluded from the cutting yield. Intermediate values can be used, in other words, veneer sheets with these values can be made (value factor 0.4-0.6), unless a sheet size fulfilling a more suitable dimension is not available in the veneer section in question.

The calculated cutting line indicates a minimum length for the stripe to be cut, i.e. the stripe must have a length of at least certain number of full feet. Also lengths over said minimum are acceptable, in case the next full foot is not available in that section. Extra lengths are removed by trimming in the subsequent jointing machine.

The apparatus 13 performing the cutting can be implemented with several different constructions, a rotary saw with a plurality of knife discs being illustrated in FIGS. 2 and 3. The disks are controllable up and down (16) and in addition eventually in the transversal direction (17) of the veneer sheeting. On the other hand, each transversal cutting position, with a pitch of about 2′+n′, can be provided with one knife having a controlled up-and-down function.

The apparatus 14 performing the logical calculations and decisions is usually a computer of PC level, industrial version. The operating system to be used in the computer must be of real-time type, due to the high-speed operation required from the apparatus. A person skilled in the art is able to compile the required program for running the operation, for example by using the C programming language.

1. A method for utilizing partial sheet veneer in the veneer production, in which method the veneer sheeting peeled from a log is monitored for defects with a machine vision device, the defective sections of the sheeting are evaluated and localized as partial sheet sections on the monitored defect information, each of the partial sheet section is evaluated for the sound veneer as areas having a length of at least 2′+n′, a value factor is given for each of said length of sound veneer, the partial sheet sections are separated by first cuts in the transversal direction of the veneer sheeting, and the partial sheet sections are severed by second cuts into sound veneer lengths selecting the lines for the second cuts producing maximized value factors for the lengths of said 2′+n′.

2. A method in accordance with claim 1, wherein the minimum width of 100 mm is used in the evaluation for the sound partial sheet section area to be separated.

3. An apparatus for implementing the method of claim 1, said apparatus comprising, a machine vision devices for monitoring the veneer sheeting for defects, a cutter cutting the veneer sheeting transversally in partial veneer sheet sections, an apparatus performing logical calculations on the monitored defect information and controlling the operation the cutter, wherein the apparatus includes cutting means for selectively cutting the partial veneer sheet sections in selected lengths on command of said apparatus performing logical calculations.
